(19) United States
(12) Patent Application Publication
(10) Pub. No.: US 2012/0217206 A1
(43) Pub. Date: Aug. 30, 2012

(54) Treatment System and Method for Shallow Water and Saturated Soil Environments

(76) Inventors: Robert S. Brown, III, Friendswood, TX (US); Robert S. Brown, IV, Friendswood, TX (US); Larry Howell, JR., Phoenix, AZ (US)

(21) Appl. No.: 13/218,409

(22) Filed: Aug. 25, 2011

Related U.S. Application Data
(60) Provisional application No. 61/376,747, filed on Aug. 25, 2010.

(51) Int. Cl. C02F 1/00

(52) U.S. Cl. 210/747.5; 210/170.01

(57) ABSTRACT

The present application is directed to a system for collecting surface material in marine environments, comprising (1) one or more arm members extendable from an operation platform; (2) at least one sprayer releasably attachable to a distal end of at least one arm member; (3) at least one skimmer releasably attachable to a distal end of at least one arm member, the skimmer being operationally configured to collect material from a water surface; and (4) a fluid delivery means in fluid communication with the sprayer, the sprayer being operationally configured for linear discharge of fluid to a target, the direction of fluid discharge being adjustable in relation to the location of the operation platform.

### CROSS-REFERENCE TO RELATED APPLICATIONS

The application is entitled to the benefit of the filing date of the prior-filed provisional application No. 61/376,747, filed on Aug. 25, 2010.

### STATEMENT REGARDING FEDERALLY SPONSORED RESEARCH OR DEVELOPMENT

Not applicable.

### FIELD OF THE APPLICATION

The application relates generally to environmental treatment efforts such as clean-up and containment efforts in marine, shallow water and/or saturated soil environments.

### BACKGROUND

Oil spills, leaks and other unwanted dumping of pollutants in marine environments including coastal waters, lakes, rivers and the like, not only potentially affects the habitats and nesting areas of birds, invertebrates, and fish, but often affects the environment itself. For example, coastal wetlands including marshlands, which often serve as coastal barriers, may be eroded from the loss of vegetation due to contamination and/or by soil disruption caused be human clean-up efforts.

Non-invasive treatment techniques are desired.

### SUMMARY

The present application is directed to a system for collecting surface material in marine environments, comprising (1) one or more arm members extendable from an operation platform; (2) at least one sprayer releasably attachable to a distal end of at least one arm member; (3) at least one skimmer releasably attachable to a distal end of at least one arm member, the skimmer being operationally configured to collect material from a water surface; and (4) a fluid delivery means in fluid communication with the sprayer, the sprayer being operationally configured for linear discharge of fluid to a target, the direction of fluid discharge being adjustable in relation to the location of the operation platform.

The present application is also directed to a system for collecting oil/water mixtures in marine environments, comprising (1) one or more articulating hydraulic booms attached to an operation platform; (2) a sprayer releasably attachable to a distal end of a first boom; (3) a self-leveling skimmer releasably attachable to a distal end of a second boom, the skimmer being defined by a main body including four mouths for receiving oil/water mixtures into the skimmer; and (4) a pump in fluid communication with the sprayer, the sprayer being operationally configured for linear discharge of fluid to a target, the direction of fluid discharge being adjustable in relation to the location of the operation platform.

The present application is also directed to a method of washing wet oil from marsh grass, including the steps of: (A) providing a system including (1) a shallow water barge, (2) an articulating hydraulic boom secured to the barge, (3) a sprayer releasably attachable to a distal end of the boom, the sprayer being operationally configured for linear discharge of water therefrom, (4) a skimmer releasably attachable to the distal end of the boom, the skimmer being operationally configured to collect wet oils from the surface of the marsh water and pump the wet oils to a reservoir located on the barge; (5) a fluid delivery means in fluid communication with the sprayer including (a) a pump means located on the barge, and (b) a conduit in fluid communication with the pump means and the sprayer, the pump means being operationally configured to convey ambient water from the surrounding marsh to the sprayer; and (6) a fluid recovery means in fluid communication with the skimmer; (B) positioning the barge near marsh grass to be cleaned, the boom being fitted with the sprayer; (C) pumping ambient water to the sprayer, the sprayer being oriented above the marsh grass and to provide downward directional water discharge onto the marsh grass substantially in the direction of the barge at an angle from about 25 degrees to about 50 degrees relative to the surface of the water to wash the wet oil from the marsh grass; (D) replacing the sprayer with the skimmer; (E) collecting the washed wet oil from the water into the skimmer and pumping the wet oil to a container on the barge.

### BRIEF DESCRIPTION OF THE FIGURES

FIG. 1 is a simplified top view of a system of the present application.

FIG. 2 is an elevational view of an articulating hydraulic boom.

FIG. 3 is a simplified top view of a system of the present application.

FIG. 4 is a simplified top view of a system of the present application.

FIG. 5 is a simplified top view of a system of the present application.

FIG. 6 is a simplified view of an embodiment of a sprayer of the system.

FIG. 7 is a perspective view of a sprayer of the system including a fluid spray being emitted there from.

FIG. 8 is a top view of a simplified embodiment of a skimmer of the present application.

FIG. 9 is a side view of a simplified embodiment of a skimmer of the present application.

FIG. 10 illustrates a simplified additive container in fluid communication with a sprayer of the system.

FIG. 11 is a lifting head of the system.

FIG. 12 is a top view of a simplified embodiment of a skimmer of the present application.

FIG. 13 is a side view of a simplified embodiment of a skimmer of the present application.

FIG. 14 is a simplified illustration of a boom support platform of the present application.

### BRIEF DESCRIPTION

It has been discovered that surface materials including, but not necessarily limited to fluids, solids, and combinations thereof, may be targeted, relocated, and otherwise collected from shallow water and/or saturated soil environments in a non-invasive manner. Heretofore, such a desirable achievement has not been considered possible, and accordingly, the system and method of this application measure up to the dignity of patentability and therefore represents a patentable concept.

Before describing the invention in detail, it is to be understood that the present system and method are not limited to particular embodiments. It is also to be understood that the terminology used herein is for the purpose of describing particular embodiments only, and is not intended to be limiting. As used in this specification and the appended claims, the term “treat,” “treating,” “treatment” and like terms refer to the collection of materials and/or fluids from shallow water and/or saturated soil environments, and/or washing and/or cleaning vegetation in shallow water and/or saturated soil environments, and/or controlling the flow of hydrocarbon materials such as oil located in shallow water and/or saturated soil environments. Shallow water and/or saturated soil environments may include designated wetland areas depending on the target location and the regulatory body or agency governing the location. The term “non-invasive” refers to modes of treatment that do not (1) disturb grass root structures of the vegetation being treated and do not (2) disturb saturated soil of a treatment location. The term “marsh grass” refers to grass located in saturated soil conditions. Examples of marsh grass include, but are in no way limited to smooth cordgrass (spartina alterniflora), saltgrass, salt meadow cordgrass, phragmites, as found in the Gulf Coast region of the United States of America. The phrase “grass root system” means marsh grass and the surrounding saturated soil. “ANSI” stands for American National Standards Institute, headquartered in Washington, D.C. The phrase “saturated soil” refers to soil having substantially all soil pore spaces filled with water and/or other fluid(s)

In one aspect, the application provides a non-invasive system for treating vegetation contaminated with hydrocarbon materials in shallow water and/or saturated soil environments.

In another aspect, the application provides a non-invasive system for washing materials off of vegetation in shallow water and/or saturated soil environments.

In another aspect, the application provides a non-invasive system for collecting hydrocarbon materials from shallow water environments.

In another aspect, the application provides for shallow water oil clean up using a barge and one or more articulated booms, the booms being operationally configured to provide an operational treatment radius of up to about 122 meters (“m”) (400 feet (“ft”)). The boom(s) being supported by an operation platform including, but not necessarily limited to dry land, a floatable vessel, a fixed structure located on dry land, and a fixed structure located in a marine environment.

In another aspect, the application provides a system for collecting surface materials in shallow water environments, the system making use of a skimming barge and processing up to about 835 kiloliters (7,000 barrels) of water per 24 hours.

In another aspect, the application provides a system for simultaneously washing materials from vegetation and collecting the wash off material in a shallow water environment.

In another aspect, the application provides a system including a fluid sprayer for emitting a fluid spray via substantially linear discharge onto marsh grass in a manner effective to remove foreign material from the marsh grass in a non-invasive manner while simultaneously directing the foreign material toward the system operator. The fluid spray including water that may be provided by the target marine environment, a fluid container, and combinations thereof.

In another aspect, the application provides an operation platform barge and one or more storage barges. The operation platform barge is fitted with one or more articulating hydraulic booms, each having a skimmer for oil collection. The collected oil/water mixture is conveyed to one or more water separator units and the separated oil is transferred to one or more storage barges. The separated water may be purified to meet regulatory requirements prior to being discharged back to the ambient water environment.

In another aspect, the application provides technology and a technique for cleaning and/or flushing marshland such as coastal marshland and sensitive marshland as defined by one or more environmental governing agencies and the like.

In another aspect, the application provides a system for use in shallow water marshlands operationally configured to collect oil from a surface of the body of water in the marshlands without disturbing or damaging animal life including, but not necessarily limited to oyster, shrimp and fishing beds located in marshland water ways.

In another aspect, the application provides a shallow water system for washing vegetation, the system being operationally configured to convey water or treated water to vegetation in a non-invasive manner.

In another aspect, the application provides a system for use in shallow water marshlands operationally configured to collect oil from a surface of the body of water in the marshlands via a skimmer operationally configured to collect oil/water mixtures requiring the skimmer to maintain a level orientation in relation to the surface of the body of water.

In another aspect, the application provides a system for simultaneously washing materials from vegetation, collecting the wash off material in a shallow water environment while also oxygenating the shallow water environment.

In another aspect, the application provides a system including a water feed that has been treated with one or more chemical additives, the water feed being effective for washing materials from vegetation in marine environments. The chemical additives are selected based on the materials to be washed from the vegetation and/or on one or more intended environmental effects. Environmental effects include, but are not necessarily limited to affecting the biochemical oxygen demand (“BOD”) of a body of water, affecting the chemical oxygen demand (“COD”) of a body of water, affecting the total organic carbon (“TOC”) of a body of water, and combinations thereof. It is also contemplated that water and/or other fluids of various temperatures may be fed to the target vegetation as desired.

In another aspect, the application provides a floating vessel equipped with an articulating hydraulic boom, the floating vessel being operationally configured to navigate wetland waterways such as coastal marshland in a non-invasive manner.

In another aspect, the application provides a system including an operation platform for supporting a boom extending there from, the operation platform including, but not necessarily limited to dry land, a floatable vessel, a fixed structure located on dry land, a fixed structure attached to dry land, and a fixed structure located offshore.

In another aspect, the application provides a system operationally configured to provide simultaneous fluid delivery, fluid recovery, fluid collection, and solids collection.

In another aspect, the application provides a system operationally configured to provide simultaneous fluid delivery, fluid recovery, fluid collection, and solids collection, the system including sealing means for effective delivery of pressurized fluid during system operation.

In another aspect, the application provides a system operationally configured to provide fluid delivery, fluid recovery, fluid collection, and solids collection, at an offshore location. Refueling of the system components being provided by tug boats and the like. Tug Boats may also be utilized to move storage barges of the present system, for example, to an offload facility and return with a fresh or empty barge to a treatment location.

In another aspect, the application provides a system including a dedicated maneuvering barge to assist system operation in predetermined water current conditions, positioning, and as a central command center for safety monitoring, shift control/documentation, depth monitoring, weather monitoring, oil slick position and as a communication monitoring platform for the present system.

### Discussion of the System and Method

The present application provides a system and method for use in marine environments including shallow water environments like wetlands and coastal marshlands. In particular, the application provides a system operationally configured to treat marine environments including shallow water environments for purposes such as environmental clean-up, vegetation washing, and water treatment. Due to negative influences that may be caused via human intervention while performing one or more of the above tasks, the present system provides a means in which to minimize or eliminate possible environmental impact while performing the same.

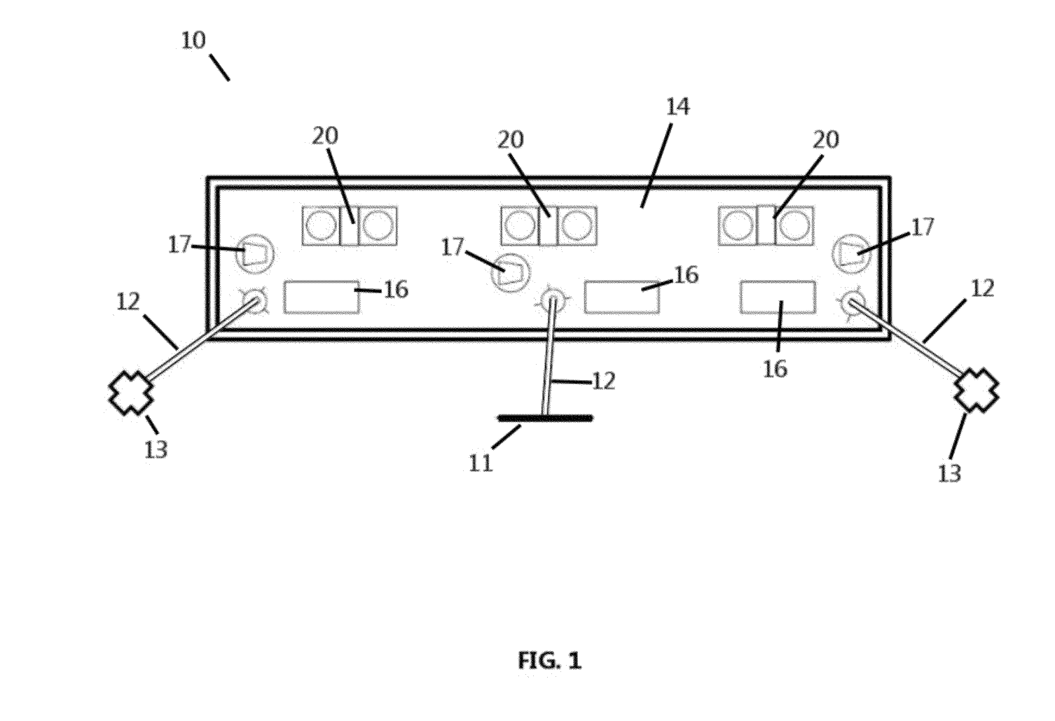

To better understand the novelty of the system and method of use thereof, reference is hereafter made to the accompanying drawings. Generally, a simplified system 10 as provided in FIG. 1 may include one or more arm members 12 operationally configured to extend out from an operation platform 14 to a desired distance. Although the system 10 may be built to scale, suitable arm members 12 are defined by a length that allows a system 10 operator to target marine environments or other targets at a predetermined distance from the target in a manner effective for minimizing or eliminating possible negative environmental impacts to the target area. Hereafter, a negative environmental impact will be referred to as a “footprint.”

Although not necessarily limited to a particular surface type, a suitable operation platform 14 is operationally configured to support the arm member 12 during system 10 operation while also providing a support surface for other system 10 parts and/or a work area for system operators. In one aspect of operation, the system 10 is operable to convey a fluid stream from the operation platform 14 to the distal end of one or more arm members 12 and out through a sprayer 11 that is fluidly connected to a conduit of the arm member 12 in a manner effective to direct the fluid stream to a target area in a marine environment at a desired target at a predetermined distance from the operation platform 14. In another aspect of operation, the system 10 is operable to collect fluid and/or solid materials from the ambient water environment or from saturated soil via a skimmer 13 or a grappling claw (not shown) and then convey the same to the operation platform 14 or other location as desired.

Still referring to FIG. 1, the system 10 may further include one or more fluid storage containers 16 for housing fluid to be emitted onto a target. As such, the system 10 suitably includes a fluid delivery means including a fluid circulation member 18 such as a positive displacement pump in fluid communication with the fluid storage container 16 that is operationally configured to convey fluid from the container 16 through a first conduit (not shown) attached to the arm member 12 and out through the sprayer 11 that is in fluid communication with a distal end of the conduit (at the distal end of the arm member 12). Without limiting the conduit to a particular construction, a suitable first conduit includes flexible hose material.

Although not necessarily limited to a particular embodiment, collection of fluids is accomplished via a skimmer 13 that is operationally configured to collect fluids at or near the water surface, e.g., oil floating on water and small floating solids. During fluid collection the skimmer 13, which is attached at the distal end of the arm member 12, is operationally configured to collect target fluid from a body of water and convey the collected fluid via a second conduit (not shown) to a storage container 20 on the operation platform 14. In an embodiment of the system 10 designed to collect spilled or leaked oil or other hydrocarbon materials, e.g., an offshore petroleum oil spill, the storage container 20 may include an oil/water separator for further processing of the oil/water mixture. Similar as above, a suitable second conduit may include flexible hose material.

In one implementation, particular arm members 12 may be designated for sole use with a sprayer 11, skimmer 13, or grappling claw (not shown). In another implementation, particular arm members 12 may be operationally configured to receive one or more of a sprayer 11, skimmer 13, or grappling claw for attachment thereto. In yet another embodiment, an arm member 12 may include each of a sprayer 11, skimmer 13, and grappling claw for multiple activity usage of the arm member 12. In an embodiment of the system 10 making use of a single arm member 12, it may be particularly advantageous to use an arm member 12 configured to receive all necessary system 10 attachments. In another embodiment of the system 10 including multiple arm members 12, each arm member 12 may be provided with a particular attachment. For example, one arm member 12 may be fitted with a sprayer 11, while second and third arm members 12 may be fitted with a skimmer 13 and grappling claw providing a system 10 operationally configured for simultaneous fluid delivery, fluid recovery, fluid collection, and solids collection. As mentioned above, the system 10 may include a first conduit for fluid conveyance from the operation platform 14 to the sprayer 11, and a second conduit for fluid conveyance from a skimmer 13 to the operation platform 14. In another embodiment, the system 10 may include a single conduit operationally configured to convey fluid in either direction. Suitably, a single conduit is provided with arm members 12 designed for use with interchanging sprayers 11 and skimmers 13.

Depending on the location to be treated, various operation platforms 14 may be employed. For example, if the treatment area is near dry land, the operation platform 14 may include the dry land or a support on or near dry land, such as a concrete slab or a dock. In another example, the operation platform 14 may include a truck or other vehicle operationally configured to support one or more arm members 12. One or more vehicles may be suitable for inland locations especially those locations for short term use or impractical for vessel use. For example, a truck carrying an arm member 12 may be desirable for treating small rivers, streams, and ponds. A suitable truck includes, but is not necessarily limited to a mobile hydraulic boom truck. In this embodiment, pressurized vacuum trucks, e.g., 9464 liters to 11356 liters (2,500 to 3,000 gallon), and/or a portable storage tank, e.g., 37854 liters (10,000 gallon), may be employed to provide fluid for system 10 use. In larger river and lake locations, a floatable vessel may be employed similar to offshore or ocean environments.

In an embodiment of the system 10 for offshore use, the operation platform 14 may include any number of floatable vessels or static structures like an oil platform. Suitable floatable vessels include ships, boats, barges and the like depending on the targeted treatment area. In one example of the system 10 for use in wetland and coastal marshlands, a suitable floating vessel may include a shallow water barge operable in water as shallow as about 2.0 m (6.6 ft). Without limiting the type of barge that may be employed, a suitable shallow water barge 14 may include the following surface platform dimensions: 42.7 m×12 m (140 ft×40 ft). Because the system 10 may be built to scale, a smaller vessel may be employed for certain treatment operations in even shallower waters, and a larger ship type vessel may be employed in deeper waters and/or for large scale treatment operations.

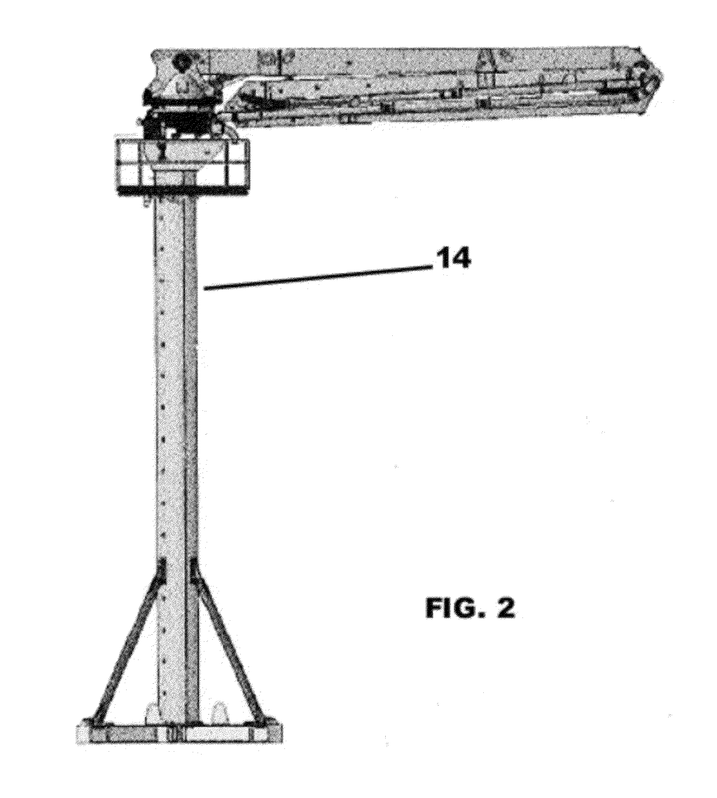

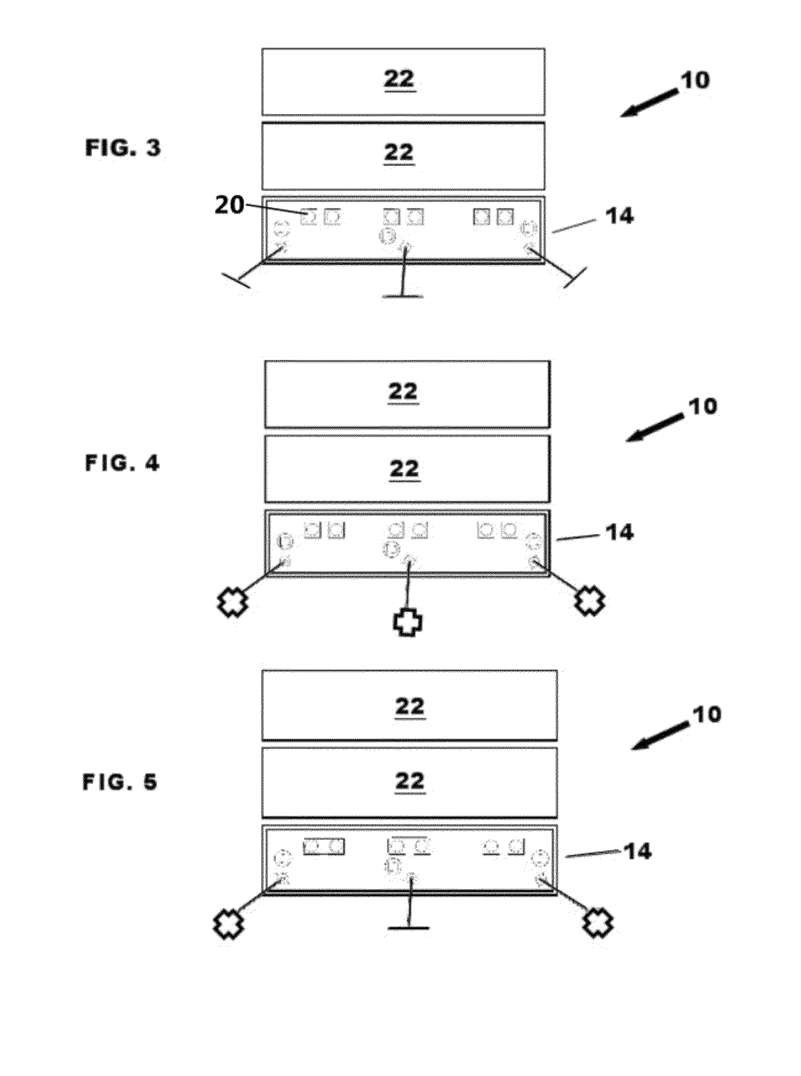

Suitable arm members 12 may include stiff arms, retractable arms, or articulating arms as desired. In an embodiment of the system 10 including a shallow water barge platform 14, a suitable arm member 12 includes, but is not necessarily limited to an articulating hydraulic boom as shown in FIG. 2. As shown in FIGS. 3-5, a suitable system 10 for use in shallow water marshlands may employ a shallow water barge platform 14, the deck being fitted with three articulating hydraulic booms 12, each boom 12 having a radius reach of about 42.0 m (138 ft). When distributed across the shallow water barge platform 14 according to FIGS. 3-5, the booms 12 suitably create a collection radius of about 116.0 m (380 ft) with about a 42.1 m (138 ft) arch. In one suitable embodiment including articulating hydraulic booms 12, the booms 12 may be torqued down to the barge platform 14 via A705 threaded studs full pin welded to 2.4 m×2.4 m×2.54 cm (8.0 ft×8.0 ft×1.0 inch) thick plates 0.95 cm (⅜ inch) fillet perimeter and welded to the barge deck including raker strengthening plates. Without limiting the invention, the articulating hydraulic booms may be operated via toggle controls and powered by 30 kw 480 3 phase generator that is grounded to the operational barge as understood by persons of ordinary skill in the art of articulating hydraulic booms.

With further attention to FIGS. 3-5, a system 10 for collecting spilled oil in shallow water marshlands may include the shallow water barge 14 discussed above in addition to one or more additional oil storage barges 22. Here, as oil/water mixtures collected via the skimmer(s) 13 is separated in the oil/water separator(s) 20, the separated oil is further directed to an oil storage barge 22 adjacent the shallow water barge 14. The separated water may be collected in a storage container or dumped back into the ambient water. Suitably, the barges of the system 10 are tethered or otherwise joined via cable or the like. Without limiting the type of barge that may be employed, a suitable storage barge 22 may include the following dimensions: 91.4 m×36.6 m (300 ft×120 ft) with a fluid storage capacity of about 159.0 liters to about 37854 liters (42.0 gallons to about 10,000 gallons). Both the dimensions of the barge 22 and the number of storage containers may vary depending upon availability and/or need.

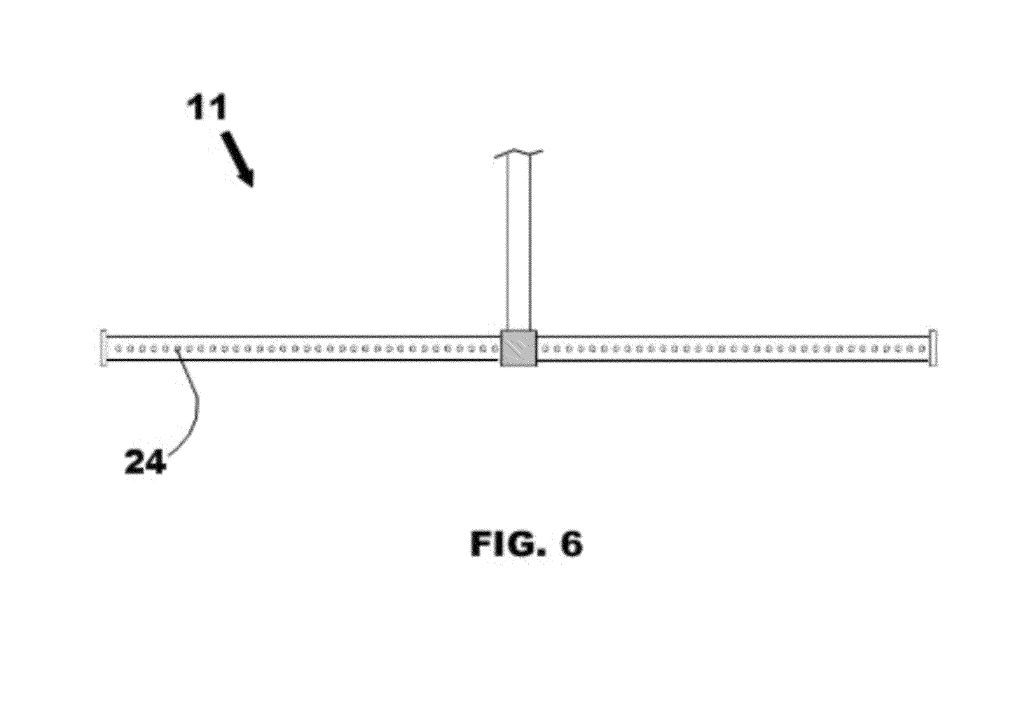

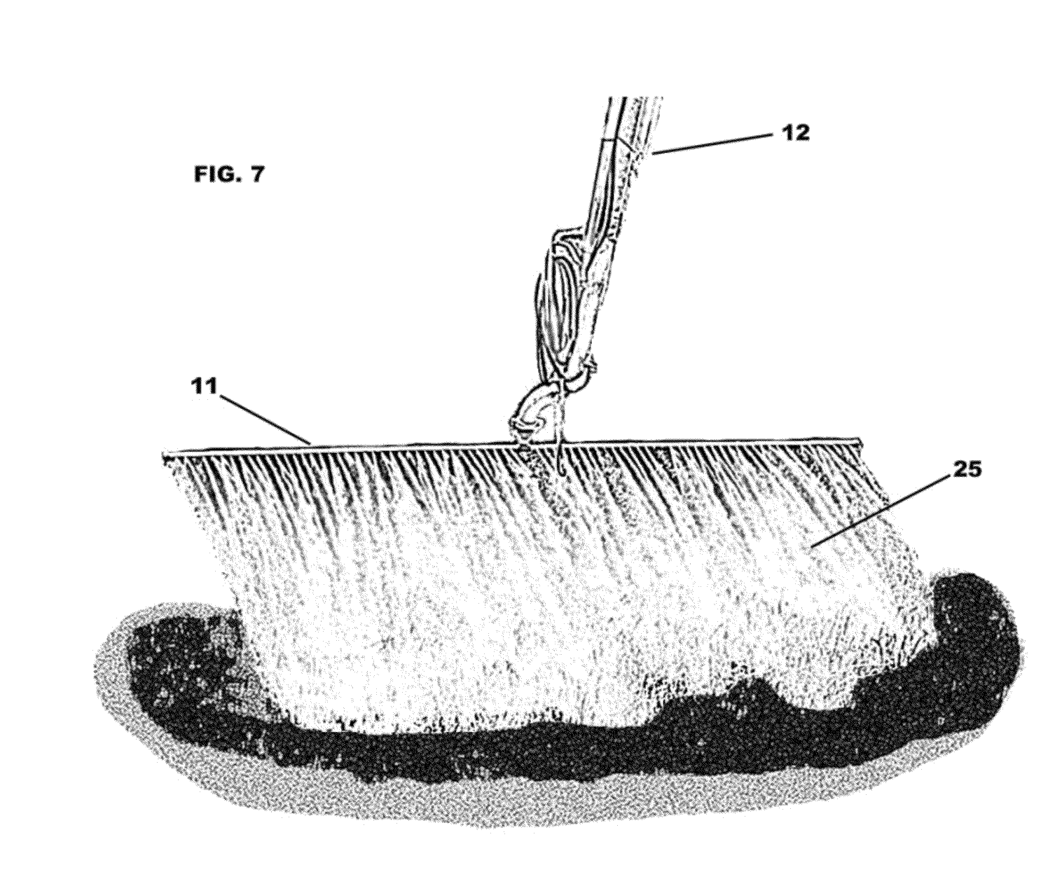

Turning to FIG. 6, a suitable sprayer 11 includes an elongated member operationally configured to provide linear discharge of fluid there from. In one embodiment, the sprayer 11 may include a single narrow slot disposed along the length of the sprayer 11, the slot allowing for linear discharge of pressurized fluid there through. As shown in FIG. 6, the sprayer 11 may include a plurality of apertures 24 disposed along the length of the sprayer 11, each of the apertures 24 being operationally configured to provide a fluid stream 25 of a desired pressure out there through, each fluid stream being directed along a path in space substantially parallel to the other fluid streams emitted through the remaining apertures 24 as shown in the simplified illustration of FIG. 7. In the embodiment of FIG. 7, a suitable sprayer 11 used in shallow water marshland includes apertures having an inner diameter or width of about 0.16 cm to about 0.64 cm (about 1/16 inches to about ¼ inches). In one embodiment, the apertures 24 comprise substantially similar inner diameters. In another embodiment, the apertures 24 may comprise varying inner diameters to produce a particular fluid spray. In still another embodiment, the apertures 24 may increase in inner diameter starting with smaller apertures 24 located near the attachment of the fluid conduit with each additional aperture 24 increasing in inner diameter the further in distance each aperture is located from the fluid conduit.

In one embodiment, the sprayer 11 may be mated to the conduit of the arm member 12 via a slip fit. In another embodiment, the sprayer 11 and corresponding conduit may be provided with a threaded connection. In still another embodiment, the sprayer 11 may be sealed to the corresponding conduit via an outer rubber sleeve or clamp device. In another embodiment, the sprayer 11 may be mated to the conduit of the arm member 12 via a snap fit configuration.

In operation, the sprayer 11 may be oriented to provide fluid streams (collectively “fluid spray”) in any desired direction. When employed for washing wet oil from grasses in shallow water marshlands, the sprayer 11 is suitably oriented to provide a non-invasive fluid spray designed to graze the marsh grass rising above the surface of the water. In this embodiment, the sprayer 11 is suitably oriented in a manner to provide fluid spray downward in a direction toward the barge 14 and at an angle from about 25 degrees to about 50 degrees relative to the surface of the water. In such mode of operation, water spray and runoff from the marsh grass is suitably forced toward the barge 14 for skimmer 13 collection. Although the sprayer 11 may be constructed from materials as desired or otherwise required, a suitable sprayer 11 is constructed from materials including but not necessarily limited to metals, plastics, woods, fiberglass, plexiglass, filled composite materials, and combinations thereof. In particular, the sprayer 11 may be constructed of materials including but not necessarily limited to those materials resistant to chipping, cracking, excessive bending and reshaping as a result of ozone, weathering, heat, moisture, other outside mechanical and chemical influences. Likewise, the sprayer 11 may include any color or combination of colors. The sprayer 11 may also be transparent and translucent depending on individual preferences or requirements. In one embodiment, the sprayer 11 may be constructed from stainless steel. In another embodiment, the sprayer 11 may be constructed from polyvinyl chloride (“PVC”). In still another embodiment, the sprayer 11 may be constructed from aluminum.

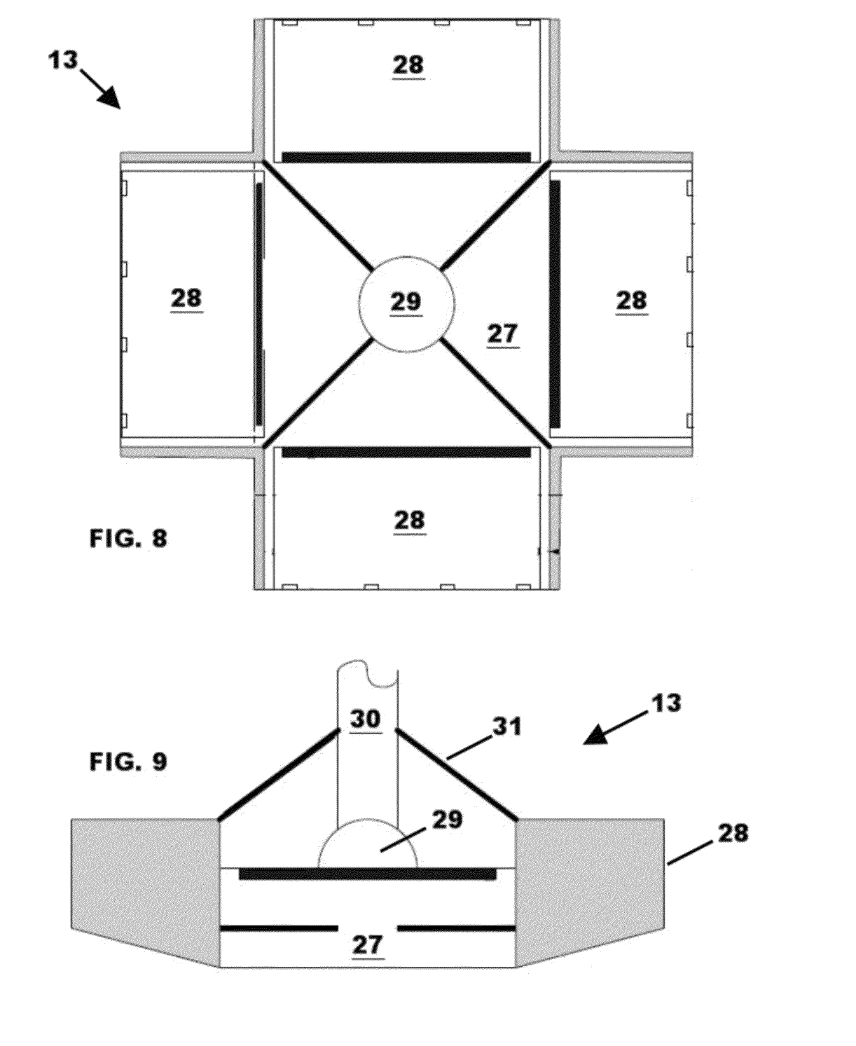

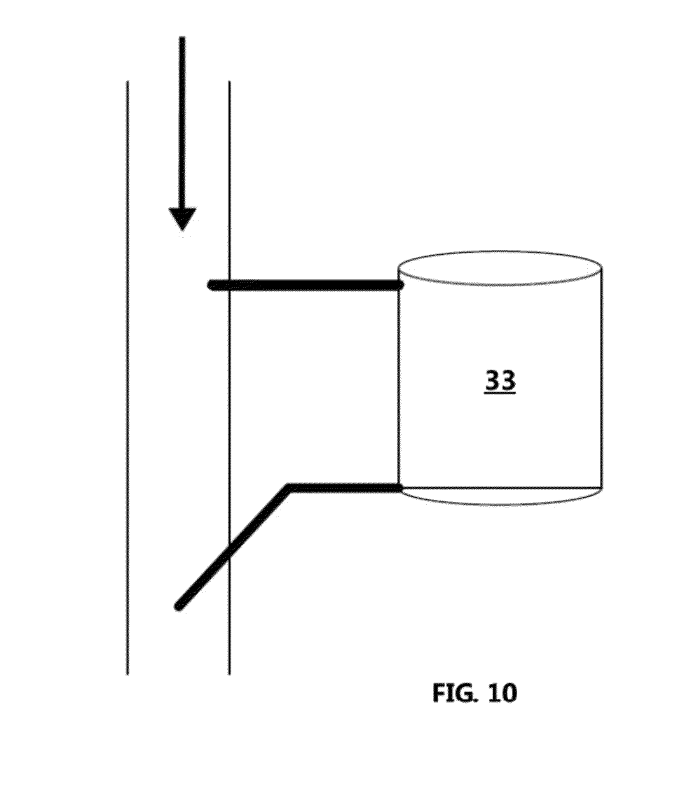

Still describing the system 10 in terms of washing wet oil from grasses in shallow water marshlands, while the wet oil flows from the grasses into the water (as provided in a multiple boom system) or after substantially all of the target wet oil is removed from the grasses (as provided in a single boom system) a skimmer 13 may be employed to collect the oil/water mixture from the water. An exemplary skimmer 13 is shown in FIGS. 8-9. As shown in FIG. 8, a suitable skimmer 13 may include a cross-shaped design including a main body 27 and up to four mouths 28 or gates operationally configured to receive fluid therein. The skimmer 13 also includes a pump 29 in fluid communication with both (1) the fluid being collected into the skimmer 13 via the mouth(s) 28, and (2) a conduit 30 in fluid communication with an oil/water separator 20 or other container on the barge 14. For structural support, the skimmer 13 may also include one or more support beams 31 for securing the skimmer 13 to the conduit 30. In operation, the pump 29 is operationally configured to convey collected oil/water mixtures to the barge 14.

Still referring to FIGS. 8-9, the design of the skimmer 13 allows for the collection of fluid(s) from the surface of a body of water without having to necessarily maintain the skimmer 13 in a level orientation relevant to the surface of the water. In one suitable embodiment, the skimmer 13 comprises buoyancy potential. In another embodiment, the skimmer 13 is maintained at a water depth during use as determined by the operator(s) controlling the boom 12.

As shown, the main body 27 suitably includes a substantially rectangular or box shape with a substantially flat bottom surface (or floor) operationally configured to hold fluid therein. The floor may also include one or more apertures allowing for a predetermined amount of fluid flow there through. Each of the mouths 28 include surfaces rising from the floor of the main body 27 at an angle ranging from about 2.0 degrees to about 10.0 degrees, which allows the skimmer 13 to operate at a greater depth over other skimmers for optimum fluid collection while also providing a safety type feature of resisting hang ups or otherwise getting caught or tangled with any vegetation or other structure(s) near the fluid collection site. In wavy or turbulent type water conditions, the skimmer 13 is suitably operationally configured in a manner whereby the top of each mouth 28 rises to match the top of an oncoming wave.

As stated, the skimmer 13 of FIGS. 8 and 9 is operationally configured to skim materials up to the edge of marsh grass without necessarily being level relative to the surface of the water. In one mode of skimmer 13 operation, the boom 12 may be joy stick operated and articulated 360 degrees. In another mode of skimmer 13 operation, the system 10 can be employed without the skimmer 13 being attached to the boom, wherein the skimmer 13 may hover just above slop mud or other materials in order to remove the target materials from estuaries, reeds and the like in waters as shallow as about 2.54 cm (1.0 inch).

Without limiting the skimmer 13 to a particular embodiment, a suitable skimmer 13 may connect to a corresponding conduit of the arm member 12 in one or more methods similar to the sprayer 11 as discussed above. In addition, the skimmer 13 may be constructed from materials including but not necessarily limited to metals, plastics, woods, fiberglass, plexiglass, filled composite materials, and combinations thereof. In particular, the skimmer 13 may be constructed of materials including but not necessarily limited to those materials resistant to chipping, cracking, excessive bending and reshaping as a result of ozone, weathering, heat, moisture, other outside mechanical and chemical influences. Likewise, the sprayer skimmer 13 may include any color or combination of colors. In one embodiment, the skimmer 13 may be constructed from stainless steel. In another embodiment, the skimmer 13 may be constructed from a plastic material. In still another embodiment, the skimmer 13 may be constructed from aluminum.

Still describing the system 10 in terms of washing wet oil from grasses in shallow water marshlands, the barge 14 is suitably fitted with one or more pumps 17 in fluid communication with the conduit 30 and operationally configured to convey the collected fluid to a storage container 20, e.g., oil/water separator. One example of a suitable pump 17 includes a plunger pump machined to fit a corresponding discharge of the conduit 30 attached to an articulating hydraulic boom 12. In a suitable embodiment, the plunger pump 17 is powered by a diesel engine with a pumping capacity of about 11356 liters per minute (3000 gallons per minute). Suitably, the discharge fluid flowing from a plunger pump 17 is directed to a corresponding oil/water separator 20. As desired, a spare or back up plunger pump 17 may also be stored on the barge 14 to ensure continued operation of the system 10 in case of pump 17 failure.

Although the system 10 may be built to scale or built depending on one or more performance requirements, a suitable oil/water separator 20 is operationally configured to process from about 1893 liters to about 3785 liters (500 to 1000 gallons per minute). The oil to water efficiency ratio of separation is suitably about 80/20 or better. The discharge may be conveyed to one or more holding barges 22 via 8.89 cm (3.5 inch) hose(s) tethered to the platform barge 14. Suitably, the water treated via the oil/water separator 20 comprises less than about 15 ppm oil (which currently complies with standards of the United States Environmental Protection Agency as of the date of this application) and may be discharged overboard. The oil/water separators 20 used are suitably powered by a diesel generator that may be shared with the one or more plunger pumps 17. Regardless of the eventual configuration, the separator 20 is suitably self contained and diesel powered. An example of a suitable oil/water separator 20 includes the characteristics described in Table 1.

TABLE 1

| Specification | Value |
|---|---|
| IMO MEPC Compliance | Uncertified, 60(33) or 107(49) |
| Test PSIG | 45 (310264 pascal) |
| Operating Pressure | 103421 pascal (15 PSIG) |
| Operating Temperature Range | 5-60 C. |
| Max Free Oil Concentration | 35% |
| Oil in Water Discharge with TPH | <15 ppm |
| Single Phase Power Options | 110 (120 vac or 220 vac) |
| Three Phase Power Options | 220, 380, 480 or 600 vac |
| DC Power Options | 12 or 24 |
| Frequency | 50 or 60 Hz |
| Max Amperage | <15 amps |
| Max Turbidity for Accurate TPH Reading | 35 NTU |
| Design Negative Inlet Head - Ft (M) | 9 (2.8) |
| Positive Inlet Head Design Pressure | 15 PSIG |
| (Motorized Valve Required) | |
| Level Sensor | Conductance |
| Pump | Centrifugal w SS Housing |
| Coalescing Media | Polypropylene or HDPE |
| Hazardous Area Classification | Nema 4X or Class I Div II |
| | or Class I Div I |
| Coating Specification | Epoxy/Urethane |
| Piping and Manual Valves | Bronze (Red Brass) |
| Vessel Metallurgy | Marine Coated Carbon Steel |

Turning to FIG. 10, the system 10 may further include an additive container 33 in fluid communication with the fluid conduit delivering fluid to the sprayer 11 of the system 10. Suitably, the additive container is attached to the arm member 12 and located downstream from the sprayer 11 in a manner effective to add one or more additives to the fluid as part of the fluid stream 25. Any additive employed is suitably designed to accomplish a predetermined purpose. In one embodiment, the additive may include one or more surfactant dispersants operationally configured to enhance oil stripping ability of the fluid stream 25. Depending on regulatory requirements and the treatment site, the additive may also include one or more solvents. Depending on the presence of any environmental regulations or restrictions governing operation of the system 10, a suitable surfactant or other additive should optimally not negatively impact the environmental effects described above although this is not a requirement for actual system 10 functioning. In another embodiment, the additive may include one or more aeration adapters operationally configured to provide oxygen and/or other gases to the fluid stream. For example, the system 10 may employ an air compressor and bubbling stone.

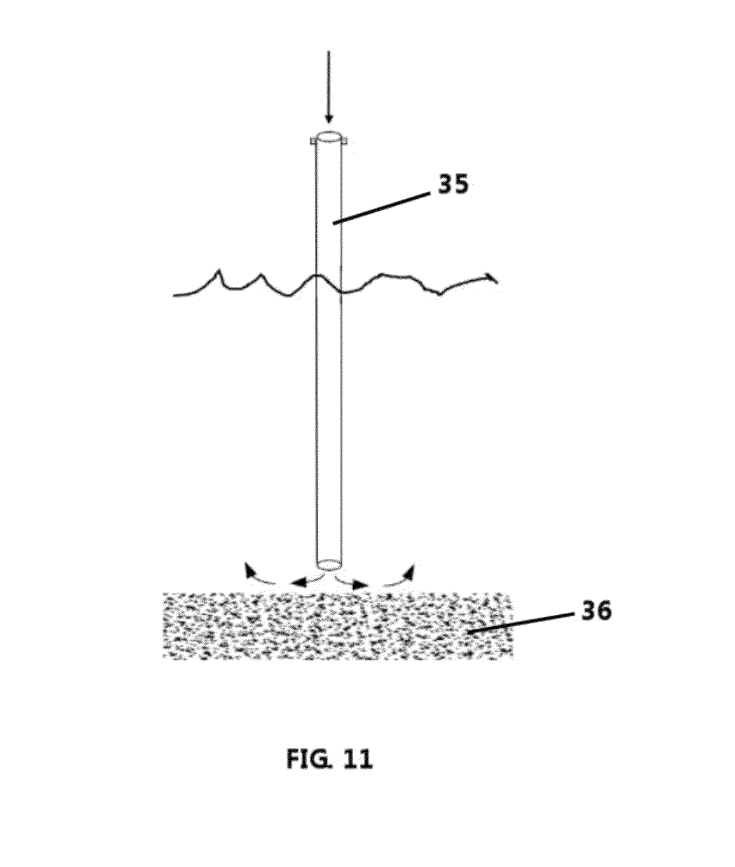

Turning now to FIG. 11, the system 10 may also be operationally configured to treat petroleum factions (often referred to as “gunk” by persons of ordinary skill in the art) that is submerged in shallow water such as marshlands and the like. As shown, a lifting head 35 may be attached to the fluid delivery conduit, the lifting head 35 being operationally configured to deliver pressurized fluid or pressurized water to the bottom of the marsh bed 36 to agitate any gunk present in order to bring the gunk to the surface for collection via the skimmer 13. In one suitable mode of operation, one or more aeration adapters may be employed to oxygenate the fluid or water that is delivered to the marsh bed 36, the resulting aeration or bubbles, along with the surface tension of the gunk, facilitating a lifting effect of the gunk.

As mentioned above, a grappling claw or like device may be interchangeably attached to the boom 12 for collecting one or more solid materials such as solids that cannot be collected via the skimmer 13. In shallow water marshlands, a grappling claw may be used to collect oil containment booms that have been pushed into marshlands where physical human recovery of the containment booms may cause a footprint. In this mode of system 10 operation, a grappling claw attached to the boom 12 may reach a predetermined distance into the marshland and recover an oil containment boom without causing a footprint in the marsh. A suitable grappling claw is commercially available from Beaver Squeezer Grapple, L.L.C., located in Corner, Ga.

The invention will be better understood with reference to the following non-limiting examples, which are illustrative only and not intended to limit the present invention to a particular embodiment.

### Example 1

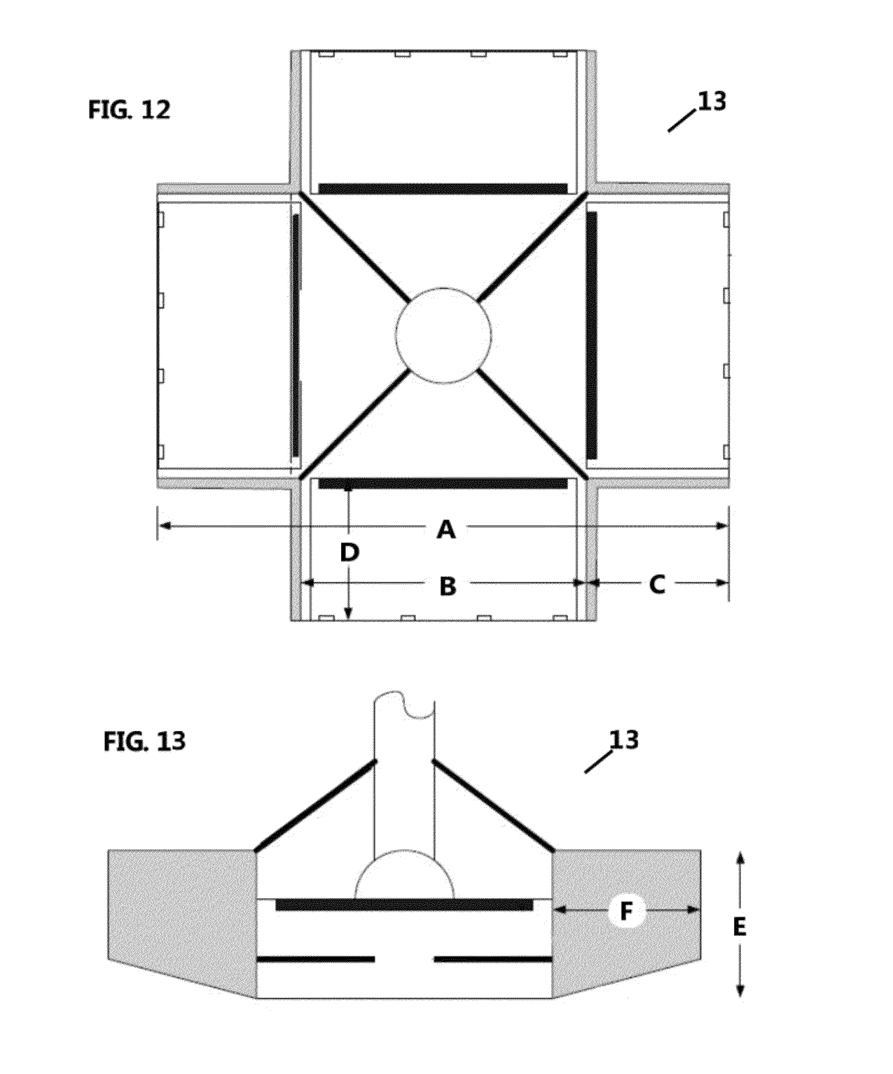

In a first non-limiting example, a system 10 for collecting spilled wet oil from marsh grass including a skimmer as shown in FIGS. 12-13 is provided. The skimmer 13 is made from stainless steel and has the following dimensions.

A: about 1.83 meters (about 6.0 feet)

B: about 0.91 meters (about 3.0 feet)

C: about 45.7 cm (about 18.0 feet)

D: about 45.7 cm (about 18.0 inches)

E: about 45.7 cm (about 18.0 inches)

F: about 45.7 cm (about 18.0 inches).

### Example 2

In a second non-limiting example, a system 10 is provided for collecting spilled wet oil from marsh grass along the Louisiana portion of the Gulf Coast region of the United States of America. The system includes a skimming barge 14, a boom 12 attached to the barge 14, an in-line sprayer 11, a skimmer 13, a water source, and a pump means as described above. The system is capable of processing from about 477 kiloliters to about 715 kiloliters (about 4,000 to about 6,000 barrels) of water per 24 hours.

Once the barge 14 reaches a desired target area of marsh grass to be treated, the boom 12 and sprayer 11 connected thereto are extended out to the target area where the sprayer 11 is positioned above the target area of marsh grass in a manner effective for the sprayer 11 to direct water spray (“pressurized water”) back toward the barge. Next, water spray is pumped from the water source out through the in-line sprayer 11 downward onto the marsh grass at an angle of about 45 degrees relative to the surface of the water. The water spray is directed onto the target area in a continuous manner until all visible wet oil is removed from the surface of the target marsh grass—the wet oil flowing into the ambient water along with the water spray.

The sprayer 11 is removed from the boom 12 and replaced with the skimmer 13 described above. The skimmer 13 is placed into the water at or near the location of the wet oil that has run off onto the surface of the water with the water spray. A pump in fluid communication with the skimmer 13 is activated and the oil/water mixture is collected from the surface of the water via the skimmer 13 and pumped to an oil/water separator 20 located on the barge 14. Due to the novel design of the above described skimmer 13, the concentration of wet oil in the oil/water mixture ranges from about 42% to about 52% of the oil/water mixture.

### Example 3

In a third non-limiting example, a system 10 as described above includes a plunger pump 17 having the following specifications:
Connections: 150 mm (6 inch) ANSI Flanges
Maximum Pump Speed: about 2000 rpm
Maximum Flow: about 455 m3/h (2000 gpm)
Maximum Head: about 50 meters (165 feet)
Maximum Static Priming Lift: about 8.5 meters (28 feet)
Water Temperature Limit: about 70° C. (160° F.)
Solids Handling Capability: about 75 mm (3.0 inches)
Maximum Casing Pressure: about 861845 pascal (125 psig)
Fuel Consumption: about 11.7 liters (3.1 gallons) per hour at full load @ 2000 rpm
Fuel Tank Capacity: about 265 liters (70 gallons) providing over 22 hours of running time

### Example 4

In a fourth non-limiting example, a system 10 as described above is provided for collecting spilled oil from a saturated soil environment. The collected oil/water is collected into storage tanks. Thereafter, a fleet of United States Department of Transportation (“DOT”) approved transportation trucks and hazardous materials certified drivers/technicians transport the collected oil/water from the storage tanks to a facility operationally configured to separate the oil and water. For example, transportation trucks used in the State of Louisiana are to be in full compliance with 33 C.F.R. §126, §154, and §156. Any transportation truck utilized should have a capacity ranging from about 11356 liters to about 24605 liters (from about 3000 gallons to about 6500 gallons).

Once the water and oil have been separated, the water is treated via one or more of biological, chemical and filtered means to provide water of a quality required for further treatment at a predetermined public water treatment facility as understood by persons of ordinary skill in the art of public water systems. For example, in the State of Louisiana, a public water treatment facility includes a facility permitted by the Gulf Coast Wastewater Authority. The separated oil is to be disposed of according to one or more regulatory authorities as necessary.

### Example 5

In a fifth non-limiting example, a system 10 as described above is provided for collecting spilled oil from a saturated soil environment. One of two transportation plans may be utilized depending upon operation conditions. In a first implementation, a land based service may be employed. In a second implementation, a sea-side service may be employed.

The land based service includes using a concrete boom pump connected directly to vacuum truck(s) to vacuum up contaminated wetlands, beaches and ocean water in one self contained system for non-invasive clean-up resulting in a zero footprint. The collected contamination fluid is vacuumed directly into one or more transportation trucks for transport to a designated disposal facility. For this implementation, a beach location has a minimum of 1.83 m (6.0 ft) of water depth to assist in the fluid transition through 1.23 m (4.0 ft) pump lines to minimize risk of conduit or pump blockage. Skimmers 13 may or may not be of use in these shallow environments.

The sea based service consists of two storage barges 22 and one operation platform 14 as previously described in FIGS. 3-5. The anchored operation platform 14 and the storage barges 22 are to be tethered. The discharge from the oil/water separator 20 on the operation platform 14 is transferred to one or more of the storage barges 22 and thereafter transported and discharged to a processing facility as understood by persons of ordinary skill in the art. Multiple barges may benefit or otherwise promote continued system 10 operations. If a processing facility is not accessible by barge 22, then the barge 22 may be offloaded to a transport truck or other holding container.

### Example 6

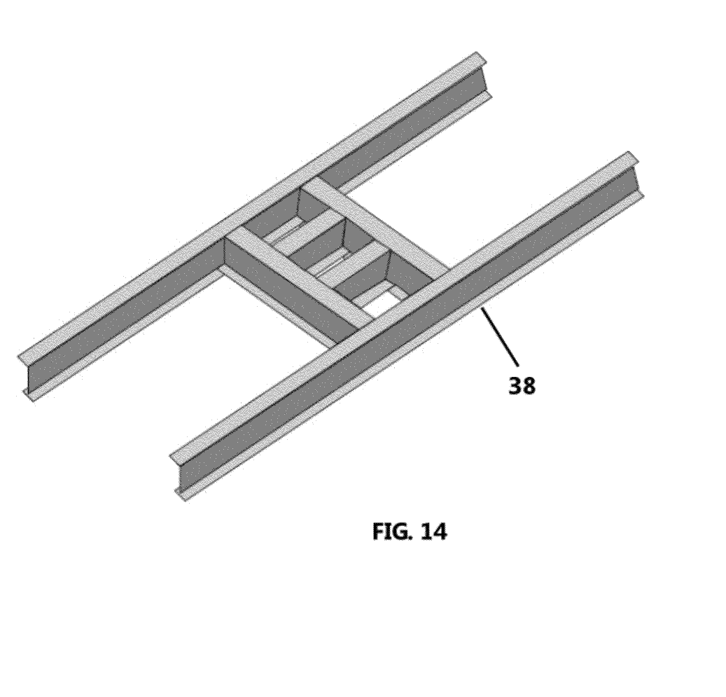

In a sixth non-limiting example, a system 10 as described above is provided for collecting spilled oil from a saturated soil environment. The system 10 includes a shallow water barge 14 operationally configured to support an articulating hydraulic boom 12. The barge 14 is suitably equipped with a boom support platform 38 as shown in the simplified illustration of FIG. 14.

The boom support platform 38 may be built to scale as necessary. In this embodiment, the boom support platform 38 is constructed from steel beams, the beams being connected via welds. The boom support platform 38 is further attached to the barge 14 via welds or fasteners as desired. This boom support platform 38 is operationally configured to distribute the load and torque across the barge 14 to improve stability and increase the surface area of wields to the deck of the barge 14.

Persons of ordinary skill in the art will recognize that many modifications may be made to the present application without departing from the spirit and scope of the application. The embodiment(s) described herein are meant to be illustrative only and should not be taken as limiting the invention, which is defined in the claims.

We claim:

1. A system for collecting surface material in marine environments, comprising:
one or more arm members extendable from an operation platform;
at least one sprayer releasably attachable to a distal end of at least one arm member;
at least one skimmer releasably attachable to a distal end of at least one arm member, the skimmer being operationally configured to collect material from a water surface; and
a fluid delivery means in fluid communication with the sprayer, the sprayer being operationally configured for linear discharge of fluid to a target, the direction of fluid discharge being adjustable in relation to the location of the operation platform.

2. The system of claim 1 wherein surface material includes materials selected from the group consisting fluids, solids, and combinations thereof.

3. The system of claim 1 wherein the sprayer includes an elongated member having a plurality of apertures disposed along the length of longitudinal member, the apertures being operationally configured as fluid outlets of the sprayer.

4. The system of claim 1 further including a fluid recovery means in fluid communication with the skimmer.

5. The system of claim 1 whereby the sprayer and skimmer may be interchangeably connected to the same arm member.

6. The system of claim 1 wherein the fluid delivery means includes a pump and a conduit in fluid communication with a fluid source at a first end and in fluid communication with the sprayer at a second end, the pump means being operationally configured to convey fluid from the fluid source to the sprayer.

7. The system of claim 6 further including a treatment member in fluid communication with the conduit and operationally configured to provide one or more additives to the fluid conveyed to the sprayer.

8. The system of claim 7 wherein the additive includes one or more surfactants.

9. The system of claim 7 wherein the treatment member is operationally configured to oxygenate the fluid.

10. The system of claim 1 further including a grappling claw operationally configured to collect solid materials, whereby the grappling claw may be interchangeably connected to the same arm member as the sprayer and skimmer.

11. The system of claim 1 wherein the skimmer includes a self-leveling skimmer defined by a main body including a floor and four mouths for receiving surface material into the main body, wherein each mouth opens outwardly from the main body about 90 degrees relative to adjacent mouths.

12. The skimmer of claim 11 further including a pump for conveying collected fluid to the operation platform.

13. The skimmer of claim 11 wherein the mouths include surfaces rising from the floor of the main body at an angle ranging from about 2.0 degrees to about 10.0 degrees.

14. The system of claim 1 wherein the operation platform may be selected from the group consisting of dry land, a floatable vessel, a fixed structure located on dry land, and a fixed structure located in a marine environment.

15. The system of claim 6 wherein the fluid source may be selected from the group consisting of ambient water from the target marine environment, a fluid container, and combinations thereof.

16. The system of claim 1 wherein the one or more arm members include articulating hydraulic booms.

17. The system of claim 14 wherein the floatable vessel includes a shallow water barge.

18. The system of claim 17 wherein the one or more arm members include articulating hydraulic booms, the shallow water barge including a support platform operationally configured to distribute the load and torque of the boom across the barge.

19. The system of claim 5 further including a lifting head attachable to the conduit and operationally configured to provide fluid flow below the surface of a target marine environment.

20. The system of claim 9 further including a lifting head attachable to the conduit and operationally configured to provide oxygenated fluid flow below the surface of a target marine environment.

21. The system of claim 1 operationally configured for use at water depths of about 2 meters or less.

22. A system for collecting oil/water mixtures in marine environments, comprising:
one or more articulating hydraulic booms attached to an operation platform;
a sprayer releasably attachable to a distal end of a first boom;
a self-leveling skimmer releasably attachable to a distal end of a second boom, the skimmer being defined by a main body including four mouths for receiving oil/water mixtures into the skimmer; and
a pump in fluid communication with the sprayer, the sprayer being operationally configured for linear discharge of fluid to a target, the direction of fluid discharge being adjustable in relation to the location of the operation platform.

23. A method of washing wet oil from marsh grass, including the steps of:
providing a system including (1) a shallow water barge, (2) an articulating hydraulic boom secured to the barge, (3) a sprayer releasably attachable to a distal end of the boom, the sprayer being operationally configured for linear discharge of water therefrom, (4) a skimmer releasably attachable to the distal end of the boom, the skimmer being operationally configured to collect wet oils from the surface of the marsh water and pump the wet oils to a reservoir located on the barge; (5) a fluid delivery means in fluid communication with the sprayer including (a) a pump means located on the barge, and (b) a conduit in fluid communication with the pump means and the sprayer, the pump means being operationally configured to convey ambient water from the surrounding marsh to the sprayer; and (6) a fluid recovery means in fluid communication with the skimmer;
positioning the barge near marsh grass to be cleaned, the boom being fitted with the sprayer;
pumping ambient water to the sprayer, the sprayer being oriented above the marsh grass and to provide downward directional water discharge onto the marsh grass substantially in the direction of the barge at an angle from about 25 degrees to about 50 degrees relative to the surface of the water to wash the wet oil from the marsh grass;
replacing the sprayer with the skimmer;
collecting the washed wet oil from the water into the skimmer and pumping the wet oil to a container on the barge.

24. The method of claim 23, wherein the water discharged from the sprayer contacts only the marsh grass located above the water surface.

25. The method of claim 23 whereby the washing of wet oil from marsh grass can be achieved using a barge in water as shallow as about 0.5 meters.
